(19) United States
(12) Patent Application Publication
(10) Pub. No.: US 2009/0297844 A1
(43) Pub. Date: Dec. 3, 2009

(54) Decorations for metal and non-metal surfaces

(76) Inventor: Sherry Samuelson, Sebastian, FL (US)

Correspondence Address: Sherrry A. Samuelson, 100 Harbor Point Dr., Sebastian, FL, 32958, US

(21) Appl. No.: 12/156,358

(22) Filed: May 30, 2008

(51) Int. Cl. B32B 7/12

(52) U.S. Cl. 428/343

(57) ABSTRACT

Decorations that adhere to metal and non-metal surfaces consisting of individual pieces for display during holidays, special occasions and various other times of the year. Such decorations are for decorating homes, schools, office buildings, daycare centers and similar places of celebration but are ideal for use on the exterior surface of a garage door of the type having a plurality of door panels permitted to rotate relative to each other when the garage door moves from a closed position to an open position. According to a preferred embodiment of the invention, the decorations are made of flexible, die cut plastic and mounted on metal and non-metal surfaces using magnetic strips and two sided tape.

### BACKGROUND OF THE INVENTION

1. Field of the Invention

The present invention relates to the display of decorations in and around homes, schools, retail stores, office buildings and other locations for the purpose of celebrating holidays and special occasions. Such decorations are used by the general public, businesses and non-profit organizations for the purpose of advertising various times of the year, stimulating excitement and good cheer.

2. Description of Prior Art

Holidays and special occasions are celebrated year round. To stimulate excitement and encourage celebration, many people decorate with banners, lights and other objects. Christmas is by far the most popular time of the year for decorations with Halloween a close second. But, there are scores of other holidays and special occasions that are celebrated throughout the year. Some of these include, Valentine's Day, St. Patrick's Day, Veteran's Day, birthdays, weddings, the arrival of a new baby to name a few.

It is common to decorate with themed images of each special time; pumpkins during Halloween; hearts and kisses for Valentine's Day; Santa and snowflakes for Christmas.

Decorating homes includes areas inside and out; from decorations adorning a fireplace in December to a wreath on the front door and lights hanging from the rooftops and trees. Businesses get in the spirit too hoping to keep shoppers in the mood to buy their goods. Numerous office buildings, daycare centers and schools are decorated too.

While all of these areas are ideal for decorating, one place around the home is not; garage doors. It's one of the largest flat surfaces on a home and ideal for decorating but yet few people decorate this area. Certainly a home's garage door would seem well suited for decorating. So, why aren't more decorated?

The reason seems to concern the operation of the door. Decorating such a large surface would be ideal but having the door go up and down while decorated is an entirely different matter.

It is well known that most garage doors consist of multiple hinged panels that separate when the doors open and close. These separations in the panels create gaps. These gaps can often separate the panels from each other by one or more inches.. It is possible decorations attached to the door or hanging near or on the door are likely to cause damage to the operation of the door or the door itself when objects get lodged between these panels. Therefore, any decoration must be able to remain on the door, allowing for the separation of the panels with no concern for damage to the operation of the door or the door itself as it opens and closes.

U.S. Pat. No. 6,395,369 issued to Randone demonstrates how to decorate using a banner attached via elastic strips at the top and bottom edges of a conventional garage door. A limitation in Randone's design is that it requires a large amount of material and hardware to secure the decoration to the door. This material and hardware can also be costly.

U.S. Pat. No. 6,572,238 issued to Johnson demonstrates how to decorate a garage door using strings of lights with just enough slack between each door panel to allow each panel to separate as the door opens and closes. A limitation is that it is still possible for the wires to become logged in the area between the panels as the door goes up and down. Another limitation is the possibility of electrocution since most garage doors are made of steel.

U.S. Pat. No. 5,943,803 issued to Zinbarg demonstrates how to decorate a garage door with multiple rectangular decorative panels using double sided tape. As the door goes up, the panels separate. The rectangular decorative panels return to their original positions when the door closes. A limitation with Zinbarg's design is the cost of producing multiple large panels. Another limitation with Zinbarg's design is being a mural with only a single way to display the panels.

U.S. Pat. No. App. 20010008702 issued to Vela reduces the amount of material used to decorate. Vela die cuts flexible magnetic material which then adheres to any ferrous surface. Vela demonstrates in U.S. Pat. Application No. 20010008702 how to reduce the amount of material needed to effectively decorate a garage door. Vela die cuts magnetic sheets into individual pieces of decorative artwork without the need for one or more large mural-like or canvas-like panels. A limitation of this design is the use of magnetic sheeting since this type of material is very expensive. Another limitation is the weight of the die cut magnetic sheeting. Shipping such a heavy material would increase the cost of such a product compared to lightweight canvas or plastic panels making it impractical to produce and market at reasonable prices for such a product.

### BRIEF DESCRIPTION OF THE DRAWINGS

In order that the invention be readily understood, a specific embodiment thereof will now be described, by way of example only and with reference to the accompanying drawings in which;

FIG. 1, FIG. 2, FIG. 3, FIG. 4, FIG. 5 and FIG. 6 are a detailed view of an exemplary decoration according to an embodiment of the present invention;

FIG. 8, FIG. 9 and FIG. 10 are a back view of an exemplary decoration according to an embodiment of the present invention;

FIG. 11, FIG. 12, FIG. 13 and FIG. 14 are a two piece view of an exemplary decoration according to an embodiment of the present invention;

FIG. 15 and FIG. 16 is a display view of an exemplary decoration according to an embodiment of the present invention;

FIG. 17 and FIG. 18 is a non display view of an exemplary decoration according to an embodiment of the present invention.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

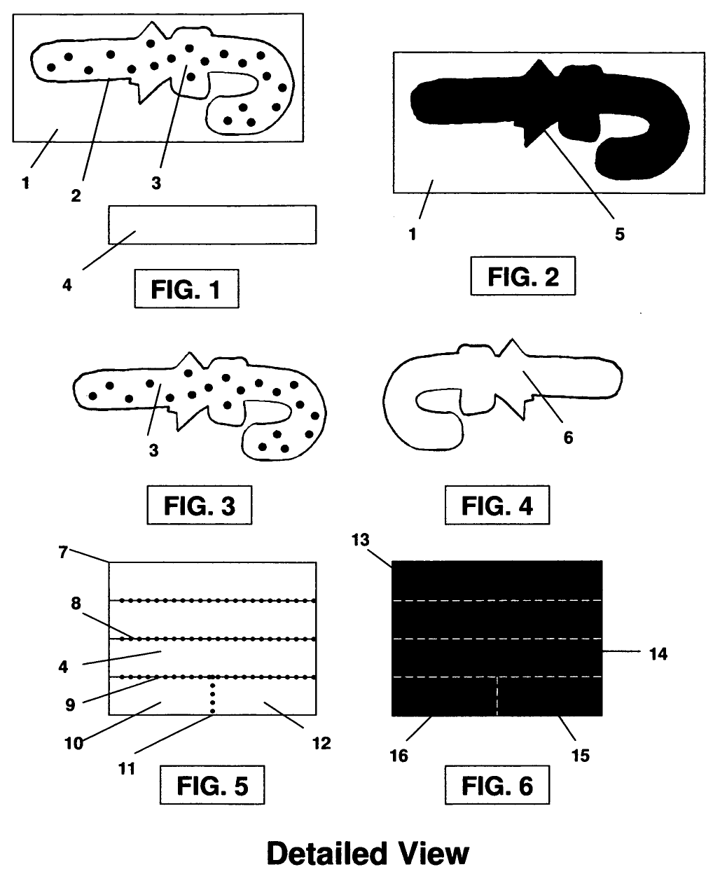

As shown by way of example in FIG. 1, a decoration in accordance with the present invention includes a sheet material 1, a die cut 2, a decoration 3 and an adhesive strip 4.

FIG. 2 illustrates sheet material 1 with sheet opening 5 after removing decoration 3.

FIG. 3 illustrates decoration 3 removed from sheet material 1 (shown in FIG. 1).

FIG. 4 illustrates the back side 6 of decoration 3.

FIG. 5 illustrates a perforated sheet of adhesive 7. FIG. 5 illustrates adhesive strip 4 before being removed from perforation 8 and perforation 9. FIG. 5 illustrates adhesive strip 10 before being removed from perforation 9 and perforation 11. FIG. 5 illustrates adhesive strip 12 before being removed from perforation 11 and perforation 9.

FIG. 6 illustrates the back side 14 of adhesive strip 4, the back side 16 of adhesive strip 12 and the back side 15 of adhesive strip 10.

FIG. 7 illustrates the adhesive strip 4 of back side 14 attached to the backside 6 of decoration 3. FIG. 7 illustrates the adhesive strip 10 attached to the backside 6 of decoration 3.

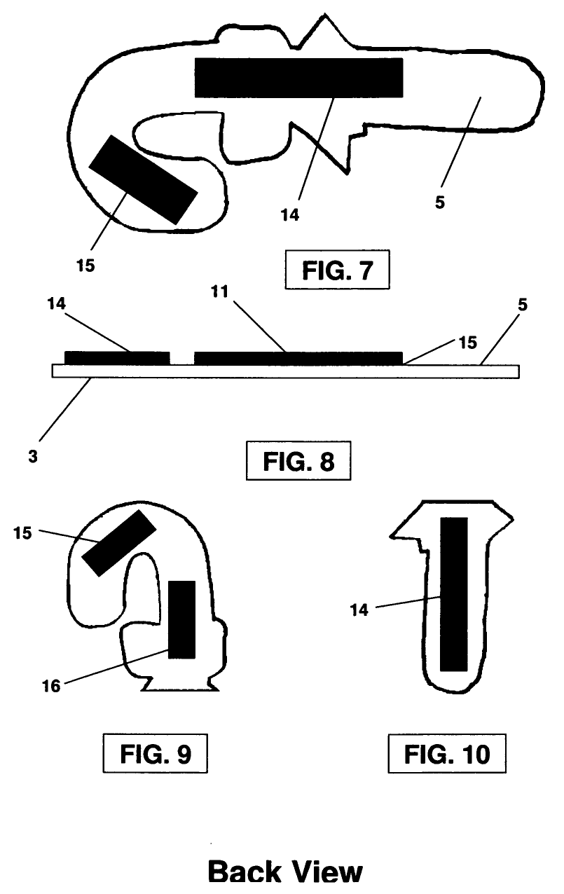

FIG. 8 is a side view of the exemplary embodiment of FIG. 7.

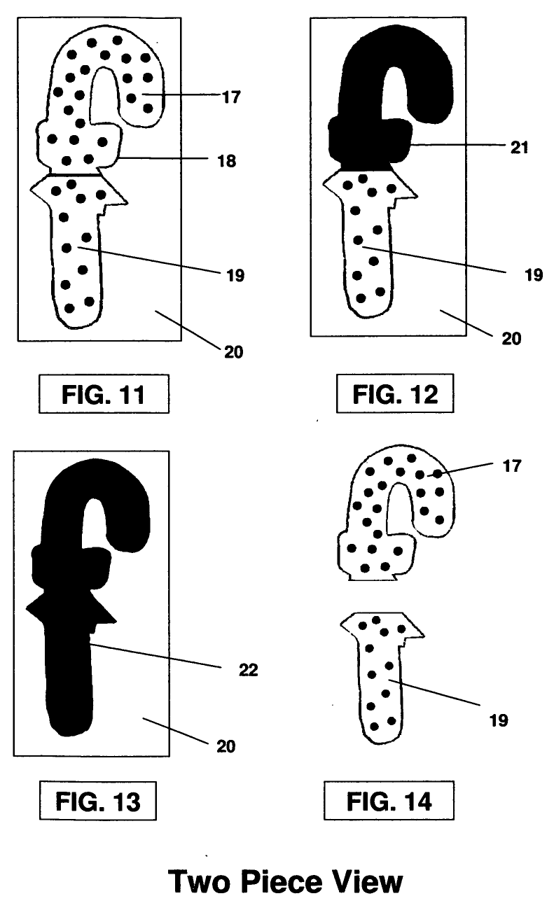

FIG. 9 illustrates adhesive strip 15 and 16 attached to decoration 19 (shown in FIG. 11).

FIG. 10 illustrates adhesive strip 14 attached to decoration 19 (shown in FIG. 11).

FIG. 11 illustrates sheet material 20 with die cut 18 around decoration 17 and decoration 17.

FIG. 12 illustrates sheet material 20 with sheet opening 21 after removing decoration 17.

FIG. 13 illustrates sheet material 20 with sheet opening 22 after removing decoration 17 and decoration 19.

FIG. 14 illustrates decoration 17 and decoration 19 removed from sheet material 20.

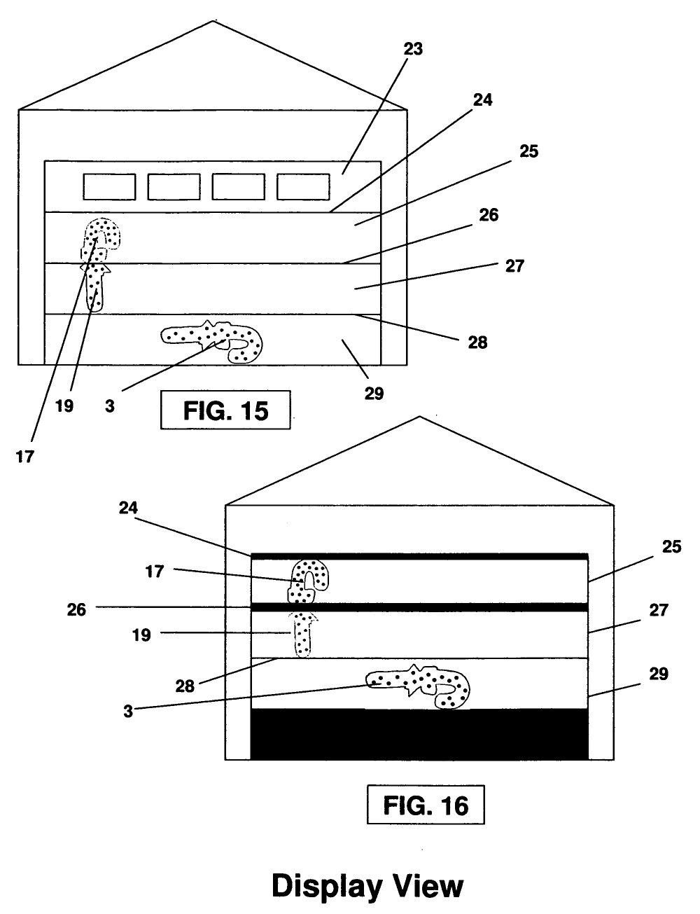

FIG. 15 illustrates, by way of example, a display view of decoration 3, 16 and 18 on garage door panels 25, 27 and 29. FIG. 15 illustrates garage door seams 24, 26 and 28.

FIG. 16 illustrates, by way of example, a garage door open half of the way whereby garage door seam 24 separates from garage door panel 25. FIG. 16 illustrates, garage door seam 26 separating from garage door panel 25 and 27. FIG. 16 illustrates decoration 16 as garage door panel 25 separates from garage door panel 27. FIG. 16 illustrates decoration 18 as garage door panel 25 separates from panel 27. FIG. 16 illustrates decoration 3 attached to garage door panel 29.

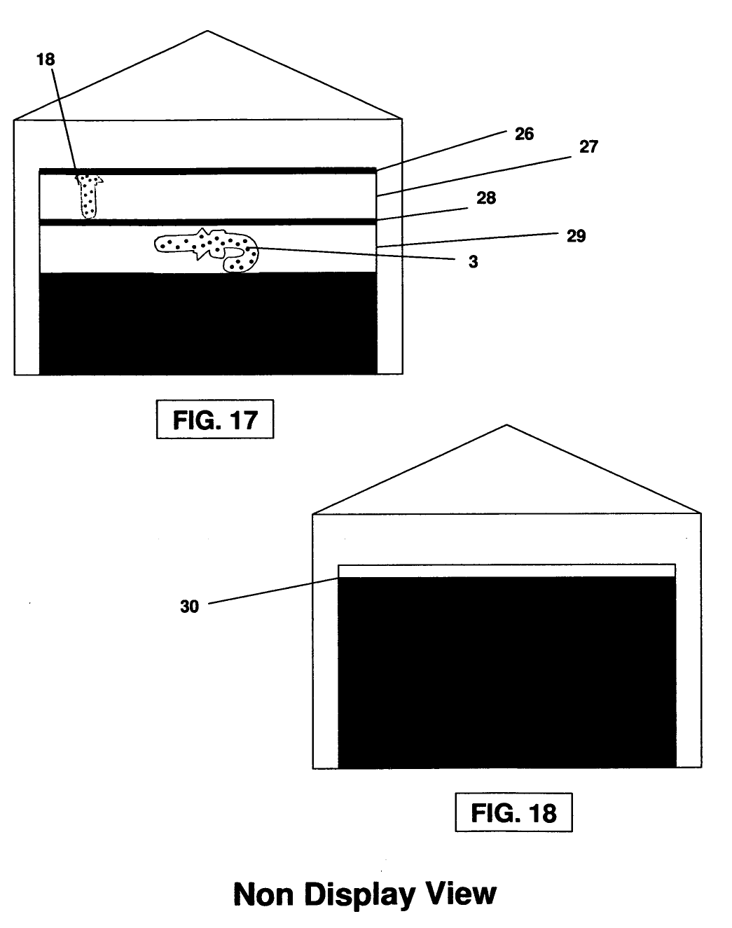

FIG. 17 illustrates, by way of example, a partially raised garage door whereby garage door seam 26 and 28 has separated from garage door panel 27 and 29. FIG. 17 illustrates decoration 18 as garage door panel 27 separates from garage door panel 29. FIG. 17 illustrates decoration 3 attached to garage door panel 29.

FIG. 18 illustrates, by way of example, a fully raised garage door 30.

### Description of Particular Embodiments

The first embodiment of decoration shown in FIG. 1 comprises a material molded of polyvinylchloride in the form of a thin sheet, then printed with decorative dots, then die cut into a shape of a candy cane.

FIG. 2 shows the sheet with the die cut candy cane removed from the sheet.

FIG. 4 shows the candy cane turned over. The back side of the candy cane in this embodiment is without graphic display but could easily enough include colorful artwork so that when displayed in a window, the artwork could be displayed on both sides of the candy cane.

FIG. 5 shows a sheet of perforated double sided tape. Each piece measures 101 mm long, 6 mm wide and 6 mm thick. The double sided tape is light weight, flexible and allows a person to use their fingers to easily cut or tear to any size suitable for use.

FIG. 6 shows a sheet of perforated magnetic strips. Each piece measures 101 mm long, 6 mm inches wide and 6 mm thick. The magnetic strips are light weight, flexible and allow a person to use their fingers to easily cut or tear to any size suitable for use.

FIG. 7 shows two pieces of magnetic strips glued to the back side of the candy cane. The candy cane is now ready to attach to a metal surface. Fixing the candy cane to a metal surface is quick and easy. Removal is also quick and easy requiring little effort.

FIG. 8 shows a side view of the candy cane shown in FIG. 7. The thickness of the sheet and the thickness of the magnetic strips are both 6 mm.

FIG. 9 and FIG. 10 shows a top half and a bottom half of a candy cane. Such pieces may be suitable when decorating above and below the seams of garage door panels as shown in FIG. 15. The magnetic strip 15 and 16 has an adhesive back side allowing it to easily attach to the candy cane top half as shown in FIG. 9 and the candy cane bottom half as shown in FIG. 10.

FIG. 11 comprises a material molded of polyvinylchloride in the form of a sheet, then printed with decorative dots, then die cut into the shape of a top half of a candy cane and die cut into the shape of a bottom half of a candy cane.

FIG. 12 shows the die cut decorative piece 17 removed from sheet 20.

FIG. 13 shows the die cut decorative piece 17 and 19 removed.

FIG. 15 shows the decorations displayed on a garage door. The use of magnetic strips makes this form of display ideal since most garage doors in the United States are made of steel. Using magnetic strips allows for ease of use and savings. FIG. 15 shows the two halves of the candy cane 17 and 19 fixed above and below seam 26 of garage door panels 25 and 27. FIG. 15 also shows candy cane 3 fixed to door panel 29.

FIG. 16 shows the garage door raised slightly causing seams 24 and 26 to separate. The candy cane 16 is not affected by the operation of the door. The magnetic strips 15 and 16 hold the decoration 17 firmly in place. Decoration 19 is also not affected by the operation of the door. Magnetic strip 14 holds the decoration firmly in place.

FIG. 17 shows the garage door half way up. The magnetic strips hold the decorative artwork firmly in place.

FIG. 18 shows the garage door fully open. Decoration 3, 17 and 19 are no longer viewable. The home owner can now close the door and once again display the decorated artwork as shown in FIG. 15. The homeowner can also easily remove and reapply the decorations in seconds. The homeowner can also choose to turn the decorative artwork in any direction he or she desires or mix and match how each piece is displayed relative to one another.

### SUMMARY OF THE INVENTION

The use of die cut materials produced with weather resistant UV protected, 4 color offset graphics, together with the use of Velcro, double sided tape and magnetic strips offers home owners a fast and easy way to decorate their garage doors. School teachers, office managers, businesses and countless others will also finds ways to use die cut graphics with Velcro, double sided tape and magnetic strips to be a cost effective and time saving alternative to other forms of decorating. Furthermore, adhesives that allow for easy removal and reuse makes die cut decorations a winning combination like never before. The ability to remove and reuse die cut materials in various materials, sizes and shapes year after year for holiday celebrations and other special occasions will save people money compared to buying cheap thin cut plastics and paper products that easily tear and wear out.

Those skilled in the art will readily recognize other useful ways to adapt the present invention in light of the prior art previously mentioned. It is to be understood that the relationship of the parts and their dimensions include variations in size, materials, shape, form, function and manner of operation, assembly and use, and are deemed readily apparent and obvious to one skilled in the art. It is further understood that all equivalent relationships illustrated in the drawings and described in the specifications are intended to be encompassed by the present invention. The illustrative drawings and the specifications described are not intended to limit the invention to the exact construction and operation shown and described since numerous modifications and changes will readily occur to those skilled in the art.

What is claimed is:

1. A die cut sheet material being sized and shaped to cover at least a portion of a metal or non-metal surface; sheet material has a front contact surface and back contact surface for graphic display and sheet material bonding to adhesive strips for mounting on wall, ceiling or similar surface.

2. The die cut sheet material of claim 1, wherein said die cut sheet material is paper, cardboard, plastic, Velcro, wood, fiberglass, glass, metal or some combination thereof.

3. The front contact surface and back contact surface of claim 1, wherein front contact surface and back contact surface permits an adhesive to bond with strips of material.

4. The strips of material of claim 3, wherein strips of material are made of paper, cardboard, plastic, Velcro, wood, fiberglass, glass, metal or some combination thereof.

5. The strips of material of claim 4, wherein said strips of material includes adhesive on one or both sides of a two sided strip.

6. The two sided strip of claim 5, wherein one side of the two sided strip bonds with front contact surface or back contact surface and other side of two sided strip bonds with paper, cardboard, plastic, Velcro, wood, fiberglass, glass, metal or some combination thereof.

7. The two sided strip of claim 6, wherein one side of two sided strip is adhesive for bonding to front contact surface or back contact surface and other side of two sided strip is magnet for bonding to metal.
